(19) United States
(12) Patent Application Publication
(10) Pub. No.: US 2016/0363531 A1
(43) Pub. Date: Dec. 15, 2016

(54) REFRACTIVE INDEX MEASUREMENT METHOD, MEASUREMENT APPARATUS, AND OPTICAL ELEMENT MANUFACTURING METHOD

(71) Applicant: CANON KABUSHIKI KAISHA, Tokyo (JP)

(72) Inventor: Tomohiro Sugimoto, Yoshikawa-shi (JP)

(21) Appl. No.: 15/174,434

(22) Filed: Jun. 6, 2016

(30) Foreign Application Priority Data
Jun. 10, 2015 (JP) 2015-117797

(51) Int. Cl. G01N 21/45; G01B 11/06; G01B 9/02

(52) U.S. Cl. CPC G01N 21/45; G01B 9/02049; G01B 11/06; G01N 2201/12; G01N 2201/068; G01N 2201/066

(57) ABSTRACT

A phase refractive index of a test object is measured with high accuracy. A phase difference between a reference light beam and a test light beam is measured by dividing light from a light source into the reference light beam and the test light beam, and causing interference between the test light beam transmitted through the test object and the reference light beam. A phase refractive index of the test object is calculated by calculating a value corresponding to an integral multiple of 2π included in the phase difference, based on a slope of a phase refractive index of a reference object with respect to wavelength.

### BACKGROUND OF THE INVENTION

### Field of the Invention

The present invention relates to a refractive index measurement method and an apparatus therefor.

### Description of the Related Art

The phase refractive index of a molded lens changes depending on molding conditions. In general, the phase refractive index of a lens after molding is measured by a minimum deviation angle method or a V-block method, after the lens is processed into a prism shape. This process is costly and time consuming. Further, the phase refractive index of the lens after molding changes due to stress release in the processing. Therefore, a technique for nondestructively measuring the phase refractive index of the lens after molding is necessary.

U.S. Pat. No. 5,151,752 discusses the following method for measuring the refractive index of molded lens. First, a test object whose phase refractive index and shape are unknown and a glass sample whose phase refractive index and shape are known are immersed into two kinds of matching fluids having different refractive indices, and then interference fringes are generated, by using coherent light transmitted through the test object and the glass sample. The phase refractive index of the matching fluid (oil) is determined from the interference fringes of the glass sample, and the phase refractive index of the test object is calculated using the phase refractive index of the oil. In addition, a non-patent literature document (H. Delbarre, C. Przygodzki, M. Tassou, and D. Boucher, “High-precision index measurement in anisotropic crystals using white-light spectral interferometry”, Applied Physics B, 2000, vol. 70, p. 45-51) discusses the following method. An interference signal between a reference light beam and a test light beam is measured as a function of wavelength, and a phase refractive index is calculated by fitting the interference signal.

In the method discussed in U.S. Pat. No. 5,151,752, the matching oil having high phase refractive index has low transmittance. Therefore, only a small signal can be obtained in transmitted wavefront measurement of the test object having high phase refractive index and thus, the measurement accuracy decreases. In the method discussed in the above-described non-patent literature document, the phase of an integral multiple of 2π is unknown and therefore, the fitting accuracy decreases.

### SUMMARY OF THE INVENTION

Embodiments of the present invention are directed to a measurement method and a measurement apparatus which are useful for measuring a phase refractive index of a test object with high accuracy. An embodiment is also directed to a method of manufacturing an optical element.

According to an aspect of the present invention, a refractive index measurement method includes measuring a phase difference between a reference light beam and a test light beam at a plurality of wavelengths, by dividing light from a light source into the reference light beam and the test light beam, and causing interference between the test light beam transmitted through a test object and the reference light beam, and calculating a phase refractive index of the test object, by calculating a value corresponding to an integral multiple of 2π included in the phase difference, based on a slope of a known phase refractive index of a reference object with respect to wavelength.

According to another aspect of the present invention, an optical element manufacturing method includes molding an optical element, and evaluating the molded optical element, by measuring a refractive index of the optical element by using the above-described measurement method.

According to yet another aspect of the present invention, a measurement apparatus includes a light source, an interference optical system configured to divide light from the light source into a reference light beam and a test light beam, and to cause interference between the test light beam transmitted through a test object and the reference light beam, a detector configured to detect interference light between the reference light beam and the test light beam, the interference light being formed by the interference optical system, and a computer configured to calculate a phase difference between the reference light beam and the test light beam, based on an interference signal obtained from the detector detecting the interference light, wherein the computer calculates a phase refractive index of the test object, by calculating a value corresponding to an integral multiple of 2π included in the phase difference, based on a slope of a known phase refractive index of a reference object with respect to wavelength.

Further features of the present invention will become apparent from the following description of exemplary embodiments with reference to the attached drawings.

### BRIEF DESCRIPTION OF THE DRAWINGS

FIG. 1 is a block diagram of a measurement apparatus (a first exemplary embodiment).

FIG. 2 is a flowchart illustrating a procedure for calculating a phase refractive index of a test object by using the measurement apparatus (the first exemplary embodiment).

FIG. 3 is a diagram illustrating an interference signal obtained by a detector (the first exemplary embodiment).

FIG. 4 is a block diagram of a measurement apparatus (a second exemplary embodiment).

FIG. 5 is an illustration of an optical element manufacturing process.

### DESCRIPTION OF THE EMBODIMENTS

Exemplary embodiments of the present invention will be described below with reference to the attached drawings.

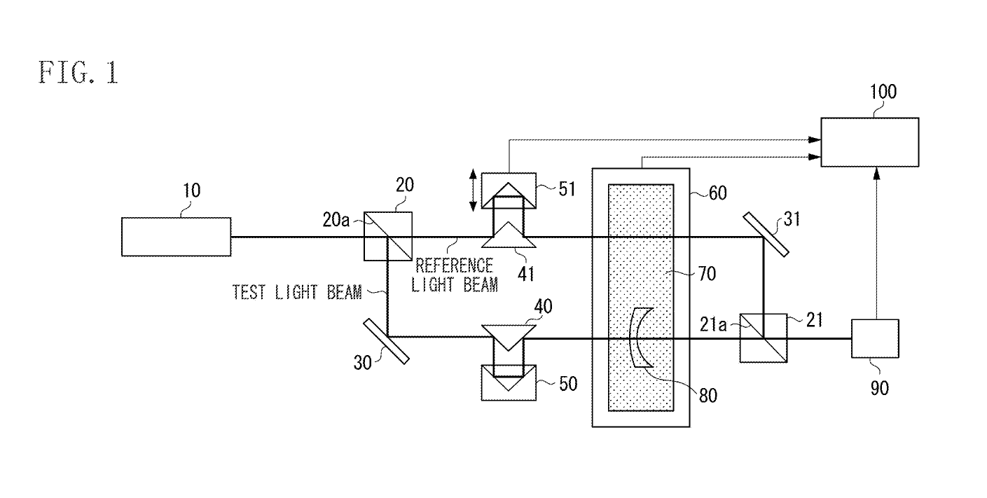

FIG. 1 is a block diagram of a measurement apparatus according to a first exemplary embodiment of the present invention. The measurement apparatus of the present exemplary embodiment is configured based on a Mach-Zehnder interferometer. The measurement apparatus includes a light source 10, an interference optical system, a container 60 capable of containing a medium 70 and a test object 80, a detector 90, and a computer 100. The measurement apparatus measures a phase refractive index of the test object 80.

Here, two types of refractive index are used. One is a phase refractive index n(λ) about a phase velocity v(λ), which is a moving speed of an equiphase surface of light. The other is a group refractive index n_{g}(λ) about a moving speed (a moving speed of a wave packet) v_{g}(λ) of energy of light. A relation between the phase refractive index n(λ) and the group refractive index n_{g}(λ) is represented by Expression 8 to be described below.

The test object 80 in the present exemplary embodiment is a lens having negative power, but may be a lens having positive power, or may be a planar element. The light source 10 of the first exemplary embodiment emits light of a plurality of wavelengths (e.g., a supercontinuum light source). The interference optical system divides the light from the light source 10 into light (a reference light beam) not to be transmitted through the test object and light (a test light beam) to be transmitted through the test object. The interference optical system causes interference by superposing the reference light beam and the test light beam, so that interference light is formed. The interference optical system then guides the interference light to the detector 90. The interference optical system includes beam splitters 20 and 21, and mirrors 30, 31, 40, 41, 50, and 51.

The beam splitters 20 and 21 are each implemented by, for example, a cube beam splitter. The beam splitter 20 transmits a part of the light from the light source 10 and simultaneously reflects the remaining light at an interface (a joint surface) 20a. In the present exemplary embodiment, the light transmitted by the interface 20a is the reference light beam, and the light reflected by the interface 20a is the test light beam. The beam splitter 21 reflects the reference light beam at an interface 21a and transmits the test light beam. As a result, the reference light beam and the test light beam interfere with each other, thereby forming the interference light. The interference light is then incident on the detector 90 (e.g., a charge coupled device (CCD) or complementary metal oxide semiconductor (CMOS) sensor).

The container 60 contains the medium 70 and the test object 80. It is preferable that an optical path length of the reference light beam and an optical path length of the test light beam in the container 60 coincide with each other, in a state where the test object 80 is not placed in the container 60. Therefore, it is preferable that each side face (e.g., glass) of the container 60 has a uniform thickness and a uniform refractive index, and both side faces of the container 60 are parallel to each other.

A phase refractive index of the medium 70 is calculated by a medium refractive index calculator (not illustrated). The medium refractive index calculator includes, for example, temperature sensor such as a thermometer for measuring the temperature of the medium 70, and a computer for converting the measured temperature to a phase refractive index of the medium. The computer may include a memory that stores a refractive index for each wavelength at a specific temperature, and a temperature coefficient of the refractive index in each wavelength. Therefore, based on the temperature of the medium 70 measured by a temperature measurement device (e.g., the thermometer), the computer can calculate the refractive index of the medium 70 for each wavelength at the measured temperature. If a temperature change in the medium 70 is small, a look-up table, which indicates data representing a refractive index for each wavelength at a specific temperature, may be used. Alternatively, the medium refractive index calculator may include a wavefront measurement sensor and a computer for calculating a phase refractive index of a medium. The wavefront measurement sensor is provided to measure a transmitted wavefront of a glass prism whose phase refractive index and shape are known, by immersing the glass prism in the medium. The computer is provided to calculate the phase refractive index of the medium, from the transmitted wavefront and the shape of the glass prism.

The mirrors 40 and 41 are each, for example, a prism mirror. The mirrors 50 and 51 are each, for example, a cube corner reflector. The mirror 51 has a driving mechanism for movement in directions indicated by the double arrow illustrated in FIG. 1. The driving mechanism of the mirror 51 includes, for example, a stage having a wide driving range (for coarse driving) and a piezoelectric stage having a high resolving power (for fine driving). A driving amount of the mirror 51 is measured by a length measuring machine (e.g., a laser displacement meter or an encoder) that is not illustrated. The computer 100 controls the driving of the mirror 51 in discrete amounts. The driving mechanism of the mirror 51 can adjust an optical path length difference between the reference light beam and the test light beam.

The detector 90 is configured of components including a spectrometer for diffracting the interference light from the beam splitter 21 and detecting an interference light intensity as a function of wavelength (frequency).

The computer 100 serves as a calculator for calculating a phase refractive index of a test object, from a detection result obtained by the detector 90 and a phase refractive index of a medium. The computer 100 also serves as a controller for controlling a driving amount of the mirror 51. The computer 100 is configured of electronic components including a central processing unit (CPU) which serves to execute programmed algorithms explained in detail below.

The interference optical system is adjusted in such a manner that the optical path length of the reference light beam and the optical path length of the test light beam are equal in a state where the test object 80 is not placed in the container 60. An adjusting method therefor is as follows.

In the measurement apparatus illustrated in FIG. 1, an interference signal between the reference light beam and the test light beam is acquired in a state where light travels through the container 60 and the medium 70, but the test object 80 is not placed on a test optical path. In this process, a phase difference φ₀(λ) and an interference intensity I_{φ0}(λ) between the reference light beam and the test light beam are represented by Expression 1.

$${φ}_{0} ( λ ) = \frac{2 π}{λ} ( - {Δ}_{0} ) \\ {I}_{φ0} ( λ ) = {I}_{0} ( 1 + {γcosφ}_{0} ( λ ) ) \qquad ( Expression 1 )$$

In Expression 1, “λ” represents a wavelength in air, and “Δ₀” represents the difference between the optical path length of the reference light beam and the optical path length of the test light beam. Further, “I₀” represents the sum of the intensity of the reference light beam and the intensity of the test light beam, and “γ” represents visibility. According to Expression 1, when Δ₀ is not zero, the interference intensity I_{φ0}(λ) becomes an oscillation function. Therefore, to cause the optical path length of the reference light beam and the optical path length of the test light beam to be equal to each other, the mirror 51 may be driven to be at a position where the interference signal does not become an oscillation function. However, when the current value of Δ₀ can be identified, it is not necessary to adjust the position of the mirror 51 to the position where the optical path length of the reference light beam and the optical path length of the test light beam become equal(Δ₀=0).

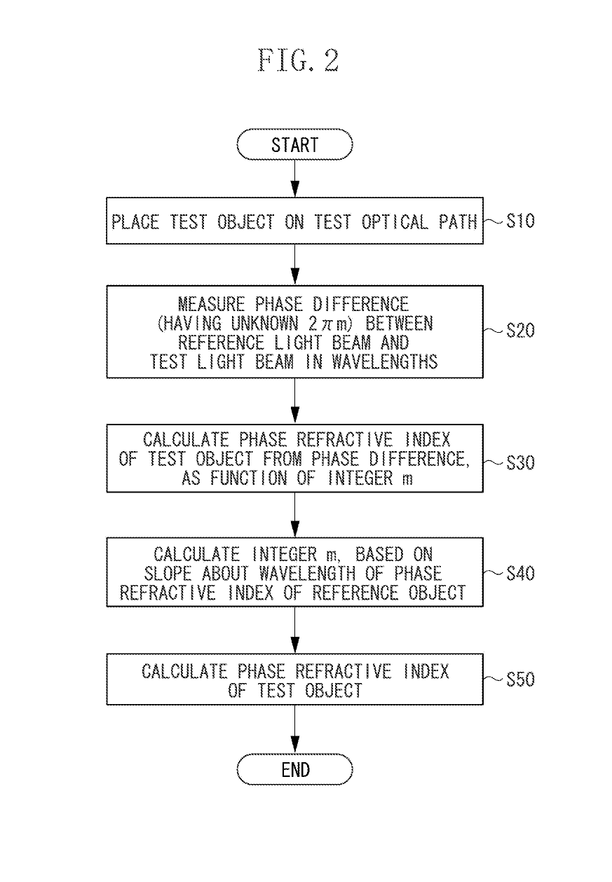

FIG. 2 is a flowchart illustrating a procedure for calculating the phase refractive index of the test object 80, and “S” is an abbreviation for “Step”.

First, in step S10, the test object 80 is placed on the test optical path. Next, in step S20, a phase difference between the reference light beam and the test light beam is measured in a plurality of wavelengths. A phase difference φ(λ) to be measured includes an unknown trim (“m” is an integer) corresponding to an integral multiple of 2π. The phase difference φ(λ) and interference intensity I(λ) are represented by Expression 2.

$$φ ( λ ) = \frac{2 π}{λ} [ ( {n}^{sample} ( λ ) - {n}^{medium} ( λ ) ) L - {Δ}_{0} ] - 2 π m \\ I ( λ ) = {I}_{0} ( 1 + γcosφ ( λ ) ) \qquad ( Expression 2 )$$

In Expression 2, “n^{sample}(λ)” represents a phase refractive index of a test object, “n^{medium}(λ)” represents a phase refractive index of a medium, and “L” represents a geometric thickness of the test object. In the present exemplary embodiment, “L” represents a thickness of a part of the test object through which the test light beam travels.

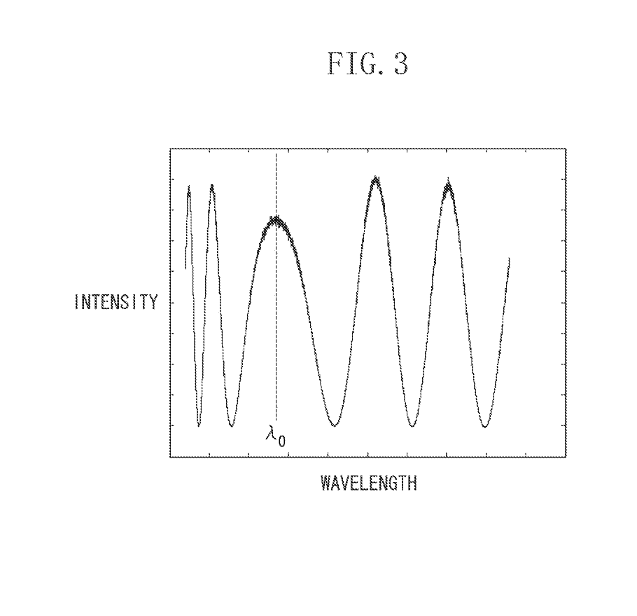

FIG. 3 illustrates an interference signal of a spectral range measured by the detector 90 illustrated in FIG. 1. The interference signal becomes an oscillation function reflecting wavelength dependency of the phase difference φ(λ). In FIG. 3, “λ₀” represents a wavelength at which the phase difference φ(λ) outputs an extremum. The interference signal has an oscillation period that becomes gentle near the wavelength λ₀ and thus, the interference signal can be easily measured at this wavelength. In contrast, at a wavelength away from λ₀, the period of the interference signal is short and thus, the interference signal may be too dense to be resolved. If λ₀ falls outside a measuring range in which the interference signal can be resolved, the value of Δ₀ may be adjusted by driving the mirror 51.

The phase difference φ(λ) can be measured using, for example, the following phase shift method. The interference signal is acquired while driving the mirror 51 in discrete steps. Expression 3 represents an interference intensity Iₖ(λ) when a phase shift amount (=driving amount×2π/λ) of the mirror 51 is δₖ(k=0, 1, to M−1), where M is a maximum number of discrete steps.

Iₖ(λ)=I₀[1+γ cos(φ)−δₖ)]=α₀+α₁ cos δₖ+a₂ sin δₖ(α₀=I₀, α₁=I₀γcos φ(λ), α₂=I₀γ sin φ(λ)) (Expression 3)

If coefficients a0, a1, and a2 are calculated by an algorithm based on the least squares method, the phase difference φ(λ) is calculated by Expression 4, using the phase shift amount δₖ and the interference intensity Iₖ(λ). To increase the accuracy of calculating the phase difference φ(λ), it is preferable that the phase shift amount λₖ is minimized, and a driving step number M is maximized. The calculated phase difference φ(λ) is wrapped by 2π. Therefore, connecting phase jumps of 2π (unwrapping) is necessary.

$$[ \begin{matrix}{a}_{0} \\ {a}_{1} \\ {a}_{2}\end{matrix} ] = {[ \begin{matrix}M & {\sum }_{k = 0}^{M - 1} cos {δ}_{k} & {\sum }_{k = 0}^{M - 1} sin {δ}_{k} \\ {\sum }_{k = 0}^{M - 1} cos {δ}_{k} & {\sum }_{k = 0}^{M - 1} {cos}^{2} {δ}_{k} & {\sum }_{k = 0}^{M - 1} cos {δ}_{k} sin {δ}_{k} \\ {\sum }_{k = 0}^{M - 1} sin {δ}_{k} & {\sum }_{k = 0}^{M - 1} cos {δ}_{k} sin {δ}_{k} & {\sum }_{k = 0}^{M - 1} {sin}^{2} {δ}_{k}\end{matrix} ]}^{- 1} [ \begin{matrix}{\sum }_{k = 0}^{M - 1} {I}_{k} \\ {\sum }_{k = 0}^{M - 1} {I}_{k} cos {δ}_{k} \\ {\sum }_{k = 0}^{M - 1} {I}_{k} sin {δ}_{k}\end{matrix} ] \\ φ ( λ ) = {tan}^{- 1} \frac{{a}_{2}}{{a}_{1}} \qquad ( Expression 4 )$$

In step S30, the phase refractive index of the test object is calculated from the phase difference φ(λ), as a function of the integer m. A phase refractive index n^{sample}(λ, m) of the test object, which is a function of the integer m, is represented by Expression 5. As apparent from Expression 5, the unknown value of 2πm of the phase difference affects the phase refractive index of the test object, as a linear function (m/L)λ of wavelength. In other words, a slope of the phase refractive index with respect to the wavelength varies depending on the value of the integer m.

$${n}^{sample} ( λ , m ) = {n}^{medium} ( λ ) + \frac{\frac{λ}{2 π} φ ( λ ) + {Δ}_{0}}{L} + \frac{m}{L} λ \qquad ( Expression 5 )$$

Next, in step S40, the integer m is calculated (the unknown corresponding to the integral multiple of 2π included in the phase difference is calculated), based on a slope of a phase refractive index of a reference object with respect to wavelength. Here, the reference object has a known phase refractive index close to the phase refractive index of the test object. For example, a base material of the test object, or an optical element produced using the same material as the test object can be the reference object.

As noted above, a phase refractive index changes significantly depending on molding conditions. However, such a change is mostly a change in a constant component independent of wavelength. There is little to no change in a slope component (a linear component) with respect to wavelength. Therefore, the integer m is calculated based on the slope of the phase refractive index of the reference object with respect to wavelength. Specifically, the integer m is calculated to minimize the difference between the slope of the phase refractive index of the test object and the slope of the phase refractive index of the reference object. Alternatively, the integer m is calculated to fall within a tolerance (e.g., an Abbe number tolerance) of the slope of the phase refractive index of the reference object.

Lastly, in step S50, the phase refractive index of the test object is calculated by substituting the integer m calculated in step S40 into Expression 5.

In the present exemplary embodiment, the geometric thickness L of the test object is assumed to be known. Therefore, it is preferable that the geometric thickness L of the test object is measured beforehand. The geometric thickness L of the test object can be measured using, for example, contact measurement utilizing a probe, or low-coherence interferometry utilizing two reference surfaces. Alternatively, using the measurement apparatus of the present exemplary embodiment, the thickness L may be measured as follows.

In a method for measuring the thickness L, after the phase difference φ(λ) represented by Expression 2 is measured, measurement is performed again to determine a phase difference φ_{ΔT}(λ), by changing the temperature of each of the test object and the medium by ΔT. The phase difference φ_{Δt}(λ) is represented by Expression 6.

$${φ}_{Δ T} ( λ ) = \frac{2 π}{λ} [ ( {n}^{sample} ( λ ) + \frac{d {n}^{sample} ( λ )}{d T} Δ T - {n}_{Δ T}^{medium} ( λ ) ) L ( 1 + αΔ T ) - {Δ}_{0} ] - 2 π ( m + Δ m ) \qquad ( Expression 6 )$$

In Expression 6, “dn ^{sample}(λ)/dT” represents a temperature coefficient of the refractive index of the test object, and “α” represents a coefficient of linear expansion of the test object. Further, “n_{ΔT}^{medium}(λ)” represents a phase refractive index of the medium after the temperature is changed by ΔT, and “Δm” represents an integer changing amount accompanying the change ΔT of the temperature. Here, dn^{sample}(λ)/dT and α are known quantities. Further, n_{ΔT}^{medium}(λ) is measured by a medium refractive index calculator (above described).

A changing rate of the phase difference with respect to wavelength is calculated from the phase difference. This calculation work is performed to remove the unknown integral multiple of 2π. Expression 7 represents a changing rate dφ(λ)/dλ (differential) with respect to wavelength of the phase difference φ(λ) of Expression 2, and a changing rate dφ_{ΔT}(λ)/dλ with respect to wavelength of the phase difference φ_{ΔT}(λ) of Expression 6.

$$\frac{d φ ( λ )}{d λ} = - \frac{2 π}{{λ}^{2}} [ ( {n}_{g}^{sample} ( λ ) - {n}_{g}^{medium} ( λ ) ) L - {Δ}_{0} ] \\ \frac{d {φ}_{Δ T} ( λ )}{d λ} = - \frac{2 π}{{λ}^{2}} [ ( {n}_{g}^{sample} ( λ ) + \frac{d {n}_{g}^{sample} ( λ )}{d T} ΔT - {n}_{g Δ T}^{medium} ( λ ) ) L ( 1 + αΔ T ) - {Δ}_{0} ] \qquad ( Expression 7 )$$

A subscript g represents a group refractive index. Expression 8 represents the relation between the phase refractive index n(λ) and the group refractive index n_{g}(λ).

$${n}_{g} ( λ ) = n ( λ ) - λ \frac{d n ( λ )}{d λ} \qquad ( Expression 8 )$$

After n_{g}^{sample}(λ) is eliminated from the two expressions in Expression 7, the thickness L is calculated as represented by Expression 9.

$$L = \frac{( - \frac{{λ}^{2}}{2 π} \frac{d {φ}_{Δ T} ( λ )}{d λ} + {Δ}_{0} ) - ( - \frac{{λ}^{2}}{2 π} \frac{d φ ( λ )}{d λ} + {Δ}_{0} ) ( 1 + αΔ T )}{( \frac{d {n}_{g}^{sample} ( λ )}{d T} Δ T + {n}_{g}^{medium} ( λ ) - {n}_{g Δ T}^{medium} ( λ ) ) ( 1 + αΔ T )} \qquad ( Expression 9 )$$

Here, dn^{sample}(λ)/dT and α, which are each assumed to be the known quantity, are, for example, values of the base material provided by a glass material manufacturer. In a strict sense, dn^{sample}(λ)/dT and α of the test object 80 are different from the values of the base material, but may be assumed to be equal to the values of the base material. This is because little to no change occurs in the temperature coefficient of the refractive index and the coefficient of linear expansion even if the refractive index of the glass material changes to some extent. Besides, the thickness L calculated using Expression 9 is insensitive to changes in the temperature coefficient of the refractive index and the coefficient of linear expansion. Therefore, only one set of the temperature coefficient of the refractive index and the coefficient of linear expansion of the glass material having the refractive index close to the refractive index of the test object may be known. In particular, an influence of the coefficient of linear expansion on the thickness L is small and therefore, no consideration may be made to the expansion of the test object 80 (i.e., the coefficient of linear expansion may be zero).

Instead of the thickness measurement using the temperature change, thickness measurement using two kinds of medium may be performed. In a method for measuring the thickness L by using two kinds of medium, after the phase difference φ(λ) represented by Expression 2 is measured (in a first medium), measurement is performed again to determine a phase difference φ₂(λ), by placing the test object in a medium (a second medium) having different refractive index from the refractive index of the first medium. A changing rate dφ(λ)/dλ of the phase difference φ(λ) and a changing rate dφ₂(λ)/dλ of the phase difference φ₂(λ) are calculated. After n_{g}^{sample}(λ) is eliminated from dφ(λ)/dλ and dφ₂(λ)/dλ, the thickness L is calculated by Expression 10. Here, “n_{g2}^{medium}(λ)” represents a group refractive index of the second medium.

$$L = \frac{( - \frac{{λ}^{2}}{2 π} \frac{d {φ}_{2} ( λ )}{d λ} + {Δ}_{0} ) - ( - \frac{{λ}^{2}}{2 π} \frac{d φ ( λ )}{d λ} + {Δ}_{0} )}{{n}_{g}^{medium} ( λ ) - {n}_{g 2}^{medium} ( λ )} \qquad ( Expression 10 )$$

In the present exemplary embodiment, the test object 80 is immersed into the medium 70 (a medium having a phase refractive index higher than the phase refractive index of air) such as oil. In the measurement method according to the present exemplary embodiment, the medium 70 may be the air. However, immersing the test object 80 into the medium 70 (other than air) has an advantage. Specifically, an influence of the power of the lens can be reduced by decreasing the refractive index difference between the test object and the medium.

In the present exemplary embodiment, the medium 70 transmits both the reference light beam and the test light beam. If the phase refractive index and the thickness of the side face of the container 60, as well as the distance between the side faces of the container 60 are known, the medium 70 may transmit only the test light beam.

Temperature distribution of the medium 70 is equivalent to refractive index distribution of the medium 70. The refractive index distribution of the medium 70 gives an error to the calculated refractive index of the test object. The error due to the refractive index distribution of the medium 70 can be corrected if the quantity of the refractive index distribution is determined. Therefore, it is preferable that a wavefront measurement apparatus for measuring the refractive index distribution of the medium 70 is provided.

In the present exemplary embodiment, the phase difference is measured by the combination of the mechanical phase shift by the mirror 51 and the spectroscopic measurement by the detector 90, but heterodyne interferometry may be used instead. If the heterodyne interferometry is used, an interferometer therefor performs measurement as follows, for example. First, a monochromator is disposed at a position following a light source, thereby causing an emission of quasi-monochromatic light. Next, an acoustic optical element causes a frequency difference between a reference light beam and a test light beam, and an interference signal is measured by a detector such as a photodiode. Subsequently, a phase difference is calculated at each of wavelengths, while the monochromator scans the wavelengths.

In the present exemplary embodiment, the supercontinuum light source is used as the light source 10 for emitting the light of the plurality of wavelengths. Instead of this type of light source, other type of light source may be used. Examples of the other type of light source include a super-luminescent diode (SLD), a halogen lamp, and a short pulse laser. When the wavelengths are scanned, a wavelength-swept light source may be used in place of the combination of the light source for emitting the light of the plurality of wavelengths and the monochromator. Alternatively, a light source having not the continuous spectrum but a discrete spectrum (e.g., a multiline oscillation gas laser) may be used. The light source is not limited to a single light source, and may be a combination of a plurality of light sources.

In the present exemplary embodiment, the configuration using the Mach-Zehnder interferometer is employed. However, a configuration using a Michelson interferometer may be adopted instead. In addition, in the present exemplary embodiment, the refractive index and the phase difference are each calculated as a function of wavelength, but may be calculated as a function of frequency instead.

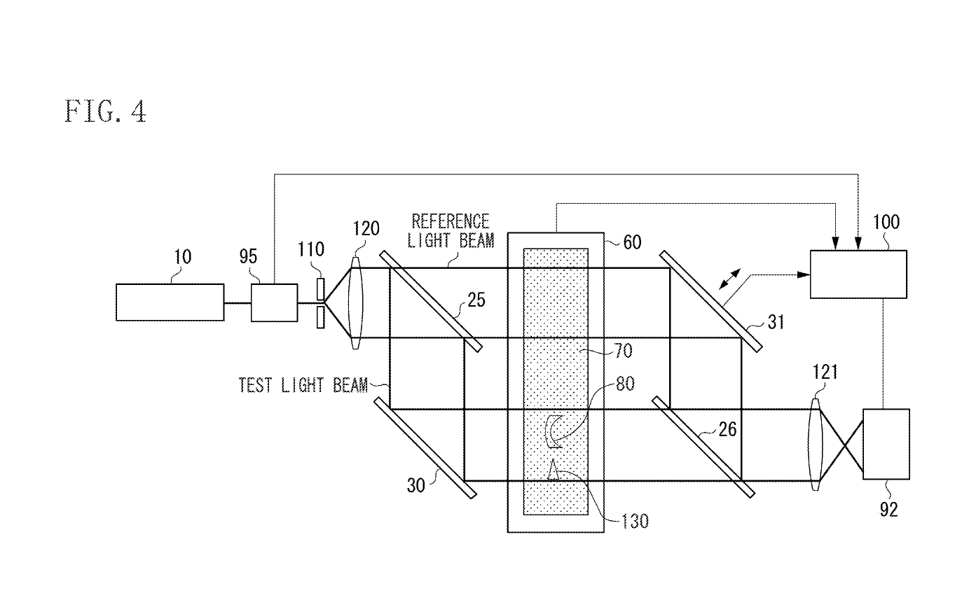

FIG. 4 is a block diagram of a measurement apparatus according to a second exemplary embodiment. A wavefront is measured using a two-dimensional sensor. A glass prism whose phase refractive index and shape are known is disposed on a test light flux to measure a phase refractive index of a medium. Configurations similar to the configurations of the first exemplary embodiment are provided with the same reference numerals as the first exemplary embodiment and will be described.

Light emitted from the light source 10 is diffracted by a monochromator 95 to become quasi-monochromatic light, and the quasi-monochromatic light is incident on a pinhole 110. The computer 100 controls the wavelength of the quasi-monochromatic light incident on the pinhole 110. Upon passing through the pinhole 110, the light becomes diverging light and then collimated by a collimator lens 120. A beam splitter 25 divides the collimated light into transmitted light (a reference light beam) and reflected light (a test light beam).

The test light beam reflected by the beam splitter 25 is reflected from a mirror 30, and then incident on the container 60 that contains the medium 70, the test object 80, and a glass prism 130. A part of the test light beam passes through the medium 70 and the test object 80. The rest of the test light beam passes through only the medium 70. These partial light beams passing through the container 60 each interfere with the reference light beam at a beam splitter 26, thereby forming interference light. The interference light is then detected by a detector 92 (e.g., a charge coupled device (CCD) or complementary metal oxide semiconductor (CMOS) sensor) as an interference signal, via an imaging lens 121. The interference signal detected by the detector 92 is sent to the computer 100.

The detector 92 is disposed at a conjugate position with the position of each of the test object 80 and the glass prism 130. It is preferable that the glass prism 130 has a phase refractive index approximately equal to the phase refractive index of the medium 70 to prevent interference fringes between the light passing through the glass prism 130 and the reference light beam from becoming too dense. In the present exemplary embodiment, it is not necessary to measure all the transmitted light of the test object 80. Only the transmitted light in a part of the test object 80 may be measured.

A phase refractive index calculator for the test object 80 of the present exemplary embodiment is as follows.

First, the test object 80 is placed on the test light flux. The phase difference φ(λ) and the phase refractive index of the medium 70 are measured by the wavelength scanning performed by the monochromator 95 and a phase shift method using a driving mechanism of a mirror 31. From the phase difference φ(λ), the phase refractive index n^{sample}(λ,m) of the test object is calculated as a function of the integer m. Based on the slope of the phase refractive index of the reference object with respect to wavelength, the unknown 2πm corresponding to the integral multiple of 2π is calculated. The phase refractive index of the test object is calculated by substituting the calculated integer m into the phase refractive index n^{sample}(λ,m).

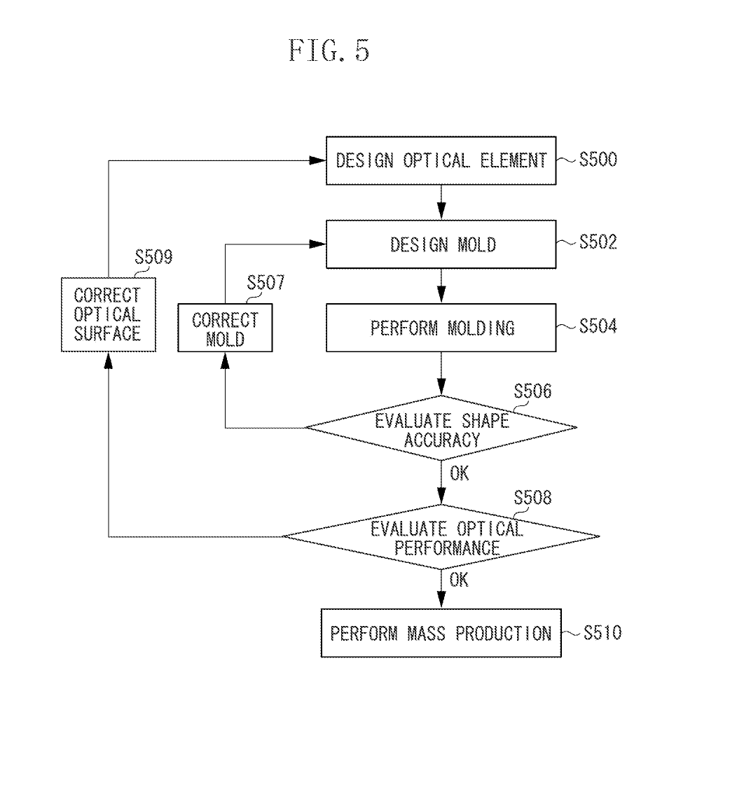

FIG. 5 illustrates a process for manufacturing an optical element utilizing molding. The optical element is manufactured by going through an optical element design step (S500), a mold design step (S502), and an optical element molding step (S504) using the mold. Next, shape accuracy of the molded optical element is evaluated at an evaluating step (S506). If the shape accuracy is insufficient (S506: NOT OK), the mold parameters are corrected (S507) and the molding design (S502) and optical element forming (S504) are performed again until the desired shape accuracy is met. If the shape accuracy is satisfactory (S506: OK), optical performance of the optical element is evaluated at S508. The measurement apparatus according to each of the exemplary embodiments of the present invention can be used for this optical performance evaluation step at S508. If the evaluated optical performance fails to satisfy required specifications (S508: NOT OK), a correction amount of an optical surface of the optical element is calculated (S509), and the optical element is designed again using a result of this calculation (S500). If the evaluated optical performance satisfies the required specifications (S508: OK), the optical element is mass-produced at the mass production step (S510).

According to the optical element manufacturing method of the present exemplary embodiment, the phase refractive index of the optical element can be accurately measured. Therefore, the optical element can be mass-produced with accuracy by molding.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-117797, filed Jun. 10, 2015, which is hereby incorporated by reference herein in its entirety.

What is claimed is:

1. A measurement method comprising:
measuring a phase difference between a reference light beam and a test light beam at a plurality of wavelengths, by dividing light from a light source into the reference light beam and the test light beam, and causing interference between the test light beam transmitted through a test object and the reference light beam; and
calculating a phase refractive index of the test object, by calculating a value corresponding to an integral multiple of 2π included in the phase difference, based on a slope of a known phase refractive index of a reference object with respect to wavelength.

2. The measurement method according to claim 1, wherein the value corresponding to the integral multiple of 2π included in the phase difference is calculated based on a difference between a slope of the phase refractive index of the test object with respect to wavelength and the slope of the phase refractive index of the reference object with respect to wavelength.

3. The measurement method according to claim 1, wherein the value corresponding to the integral multiple of 2π included in the phase difference is calculated based on a tolerance of the slope of the phase refractive index of the reference object with respect to wavelength.

4. The measurement method according to claim 1, further comprising:
measuring the phase difference between the reference light beam and the test light beam at the plurality of wavelengths in a condition where a temperature of the test object is a first temperature;
measuring the phase difference between the reference light beam and the test light beam at the plurality of wavelengths in a condition where the temperature of the test object is a second temperature different from the first temperature; and
calculating a thickness of the test object, based on the phase difference between the reference light beam and the test light beam measured at each of the first temperature and the second temperature.

5. The measurement method according to claim 1, further comprising:
measuring the phase difference between the reference light beam and the test light beam at the plurality of wavelengths, by placing the test object in a first medium;
measuring the phase difference between the reference light beam and the test light beam at the plurality of wavelengths, by placing the test object in a second medium having a refractive index different from a refractive index of the first medium; and
calculating a thickness of the test object, based on the phase difference between the reference light beam and the test light beam measured by placing the test object in each of the first medium and the second medium.

6. An optical element manufacturing method comprising:
molding an optical element; and
evaluating the molded optical element, by measuring a refractive index of the optical element,
wherein the refractive index of the optical element is measured by a measurement method including
measuring a phase difference between a reference light beam and a test light beam at a plurality of wavelengths, by dividing light from a light source into the reference light beam and the test light beam, allowing the test light beam to be incident on a test object, and causing interference between the test light beam transmitted through the test object and the reference light beam, and
calculating a phase refractive index of the test object, by calculating an a value corresponding to an integral multiple of 2π included in the phase difference, based on a slope of a known phase refractive index of a reference test object with respect to wavelength.

7. A measurement apparatus comprising:
a light source;
an interference optical system configured to divide light from the light source into a reference light beam and a test light beam, and to cause interference between the test light beam transmitted through a test object and the reference light beam;
a detector configured to detect interference light between the reference light beam and the test light beam, the interference light being formed by the interference optical system; and
a computer configured to calculate a phase difference between the reference light beam and the test light beam, based on an interference signal obtained from the detector detecting the interference light,
wherein the computer calculates a phase refractive index of the test object, by calculating an a value corresponding to an integral multiple of 2π included in the phase difference, based on a slope of a known phase refractive index of a reference object with respect to wavelength.

8. The measurement apparatus according to claim 7, wherein the computer calculates the value corresponding to the integral multiple of 2π included in the phase difference, based on a difference between a slope of the phase refractive index of the test object with respect to wavelength and the slope of the phase refractive index of the reference object with respect to wavelength.

9. The measurement apparatus according to claim 7, wherein the computer calculates the value corresponding to the integral multiple of 2π included in the phase difference, based on a tolerance of the slope of the phase refractive index of the reference object with respect to wavelength.

10. The measurement apparatus according to claim 7, wherein the computer calculates a thickness of the test object, based on the phase difference between the reference light beam and the test light beam measured at a plurality of wavelengths in a condition where a temperature of the test object is a first temperature, and the phase difference between the reference light beam and the test light beam measured at the plurality of wavelengths in a condition where the temperature of the test object is a second temperature different from the first temperature.

11. The measurement apparatus according to claim 7, wherein the computer calculates a thickness of the test object, based on the phase difference between the reference light beam and the test light beam measured at a plurality of wavelengths in a state where the test object is placed in a first medium, and the phase difference between the reference light beam and the test light beam measured at the plurality of wavelengths in a state where the test object is placed in a second medium having a refractive index different from a refractive index of the first medium.
